(19) United States
(12) Patent Application Publication
(10) Pub. No.: US 2020/0067817 A1
(43) Pub. Date: Feb. 27, 2020

(54) SENDER COMMUNICATION APPARATUS AND COMMUNICATION APPARATUS

(71) Applicants: Panasonic Intellectual Property Management Co., Ltd., Osaka (JP); Vossloh-Schwabe Deutschland GmbH, Urbach (DE)

(72) Inventors: Masafumi ODA, Fukuoka (JP); Hidemi NAKADAIRA, Fukuoka (JP); Horst KREMER-MERSEBURG, Wachtendonk (DE)

(21) Appl. No.: 16/546,925

(22) Filed: Aug. 21, 2019

(30) Foreign Application Priority Data
Aug. 22, 2018 (JP) 2018-155373
Aug. 20, 2019 (JP) 2019-150385

(51) Int. Cl. H04L 12/729; H04L 29/06; H04L 9/08; H04L 12/751; H04L 12/753

(52) U.S. Cl. CPC H04L 45/125; H04L 63/0442; H04L 63/0464; H04L 45/48; H04L 9/0825; H04L 45/02; H04L 63/06

(57) ABSTRACT

A sender communication apparatus of a power line communication system that includes: a communication apparatus that is located at a route node of a tree structure of logical connection and broadcasts a received signal; the sender communication apparatus that is located at a node other than the route node of the tree structure; and a recipient communication apparatus that is located at a node other than the route node of the tree structure, wherein the sender communication apparatus comprises a communicator that communicates with the communication apparatus and the recipient communication apparatus via a power line, and the communicator transmits transmission signals to be transmitted to the recipient communication apparatus, to the communication apparatus in a unicast manner.

### CROSS REFERENCE TO RELATED APPLICATIONS

This application is entitled to and claims the benefit of Japanese Patent Application No. 2018-155373, filed on Aug. 22, 2018 and Japanese Patent Application No. 2019-150385, filed on Aug. 20, 2019, the disclosure of which including the specification, drawings and abstract is incorporated herein by reference in its entirety.

### TECHNICAL FIELD

The present disclosure relates to a sender communication apparatus and a communication apparatus for power line communication.

### BACKGROUND ART

There are power line communications (PLC) for communication between a plurality of terminal apparatuses using a power line laid indoors as a transmission line. Conventionally, a communication method has been proposed which can perform efficient transmission, avoiding collision of signals while meeting limitations on delay dependent on data to be transmitted by a plurality of communication apparatuses using different communication methods (see, for example, PTL 1).

### CITATION LIST

### Patent Literature

### PTL 1

### Japanese Patent Application Laid-Open No. 2009-100044

### SUMMARY OF INVENTION

### Technical Problem

With PLC, for broadcast communication between communication apparatuses, signals are broadcasted at the media access control (MAC) layer level. Communication apparatuses determine whether or not the signals broadcasted at the MAC layer level are signals that should be received at the application level. For this reason, in some cases with PLC, collision between signals at the MAC layer level may be more likely to occur, which may decrease the communication rate.

Non-limiting examples of the present disclosure reduce collision between signals, and provide a sender communication apparatus and a communication apparatus for reducing a decrease in communication rate.

### Solution to Problem

A sender communication apparatus according to one aspect of the present disclosure is an apparatus of a power line communication system that includes: a communication apparatus that is located at a route node of a tree structure of logical connection and broadcasts a received signal; the sender communication apparatus that is located at a node other than the route node of the tree structure; and a recipient communication apparatus that is located at a node other than the route node of the tree structure, in which the sender communication apparatus includes a communicator that communicates with the communication apparatus and the recipient communication apparatus via a power line, and the communicator transmits transmission signals to be transmitted to the recipient communication apparatus, to the communication apparatus in a unicast manner.

A communication apparatus according to one aspect of the present disclosure is an apparatus of a power line communication system that includes: a sender communication apparatus that is located at a node other than a route node of a tree structure of logical connection; a recipient communication apparatus that is located at a node other than the route node of the tree structure; and the communication apparatus that is located at the route node of the tree structure, in which the communication apparatus comprises a communicator that communicates with the sender communication apparatus and the recipient communication apparatus via a power line, and the communicator receives, in a unicast manner, transmission signals transmitted from the sender communication apparatus, and transmits the received transmission signals to the recipient communication apparatus in a broadcast manner.

A communication apparatus according to one aspect of the present disclosure is an apparatus of a power line communication system that includes: a sender communication apparatus that is located at a node other than a route node of a tree structure of logical connection; a recipient communication apparatus that is located at a node other than the route node of the tree structure; and the communication apparatus that is located at the route node of the tree structure, wherein the communication apparatus comprises a communicator that communicates with the sender communication apparatus and the recipient communication apparatus via a power line, and the communicator receives, in a unicast manner, transmission signals transmitted from the sender communication apparatus, and transmits the received transmission signals to the recipient communication apparatus in a unicast manner.

Note that these general or specific aspects may be implemented by a system, an apparatus, a method, an integrated circuit, a computer program, or a recording medium, or any combination of a system, an apparatus, a method, an integrated circuit, a computer program, and a recording medium.

### Advantageous Effects of Invention

One aspect of the present disclosure can reduce collision between signals and a decrease in communication rate.

Further advantages and effects of one aspect of the present disclosure are apparent from the specification and the drawings. Such advantages and/or effects may be provided by some embodiments and features described in the specification and drawings, respectively; however, not all of them need to be provided to obtain one or more of the same features.

### BRIEF DESCRIPTION OF DRAWINGS

FIG. 1 is a diagram showing an example configuration of a power line communication system according to a first embodiment of the present disclosure;

FIG. 2 is a diagram showing a logical connection in a power line communication system shown in FIG. 1;

FIG. 3 is a diagram showing an example block configuration of a communication apparatus;

FIG. 4 is a sequence diagram showing example processing in which a terminal transmits packets to a master;

FIG. 5 is a sequence diagram showing example processing in which a terminal transmits packets to a master;

FIG. 6 is a sequence diagram showing example processing in which a master receives and transmits packets from/to terminals;

FIG. 7 is a sequence diagram showing example processing in which a master receives and transmits packets from/to terminals;

FIG. 8A is a flow chart showing example processing in a terminal;

FIG. 8B is a flow chart showing example processing in a terminal;

FIG. 9A is a flow chart showing example processing in a master;

FIG. 9B is a flow chart showing example processing in a master; and

FIG. 10 is a diagram showing example logical connection in a power line communication system according to a second embodiment.

### DESCRIPTION OF EMBODIMENTS

An embodiment of the present invention will now be described in detail appropriately referring to the accompanying drawings. However, excessively detailed description may be omitted. For example, detailed description of already well-known matters and redundant description of substantially the same configuration may be omitted. This is to avoid redundancy in the following description and to facilitate understanding by those skilled in the art.

It should be noted that the attached drawings and the following description are provided to enable those skilled in the art to fully understand the present disclosure, and they are not intended to limit the subject matter described in the scope of claims.

### First Embodiment

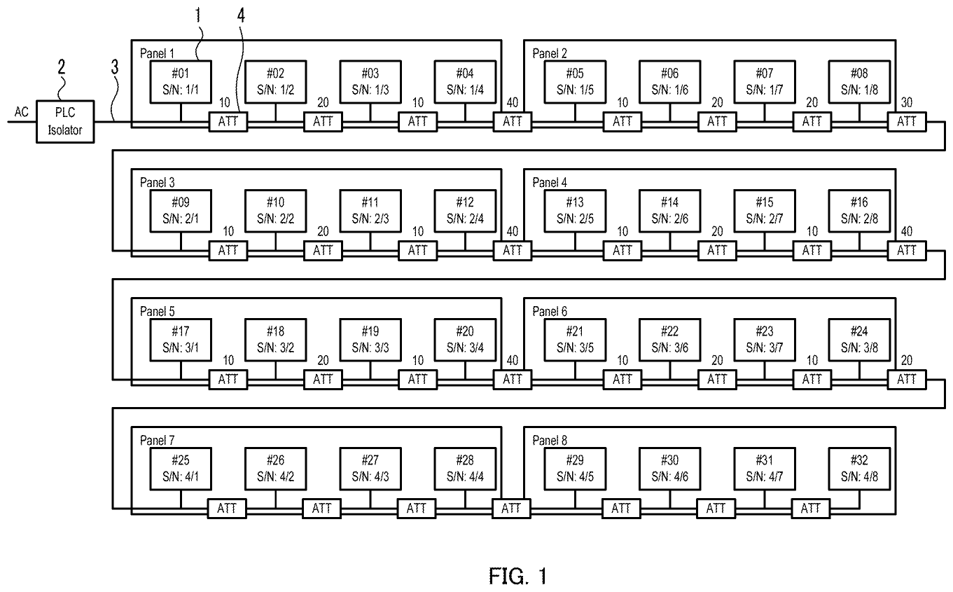

FIG. 1 is a diagram showing an example configuration of a power line communication system according to a first embodiment of the present disclosure. As shown in FIG. 1, the power line communication system includes 32 communication apparatuses 1 #01 to #32, PLC isolator 2, power source line 3, and 31 attenuators (ATT) 4. In the following description, to distinguish between 32 communication apparatuses 1, they may be denoted as communication apparatuses #01 to #32.

Communication apparatuses #01 to #32 are PLC modems for PLC. Communication apparatuses #01 to #32 each are connected to power source line 3 and communicate with each other via a power source line 3.

Communication apparatuses #01 to #32 are each connected to an electronic device (not shown in the drawing). The electronic devices communicate with each other through communication apparatuses #01 to #32.

PLC isolator 2 prevents, for example, a flow of noise from the power source to power source line 3 on the side of communication apparatuses #01 to #32. PLC isolator 2 prevents a flow of signals from communication apparatuses #01 to #32 to the power source side.

Attenuators 4 are disposed between connection points at which communication apparatuses #01 to #32 are connected to power line 3. Attenuators 4 attenuate signals propagating from communication apparatuses #01 to #32 through power source line 3.

It should be noted that the number of communication apparatuses #01 to #32 and the number of attenuators 4 are not limited to those in FIG. 1. There may be less than or more than 32 communication apparatuses 1. At most 1025 communication apparatuses 1 are connected, for example. Attenuators 4 are not necessarily provided between terminal apparatuses one by one.

In the following description, communication apparatus #01 serves as a master, and communication apparatuses #02 to #32 serve as slaves (terminals).

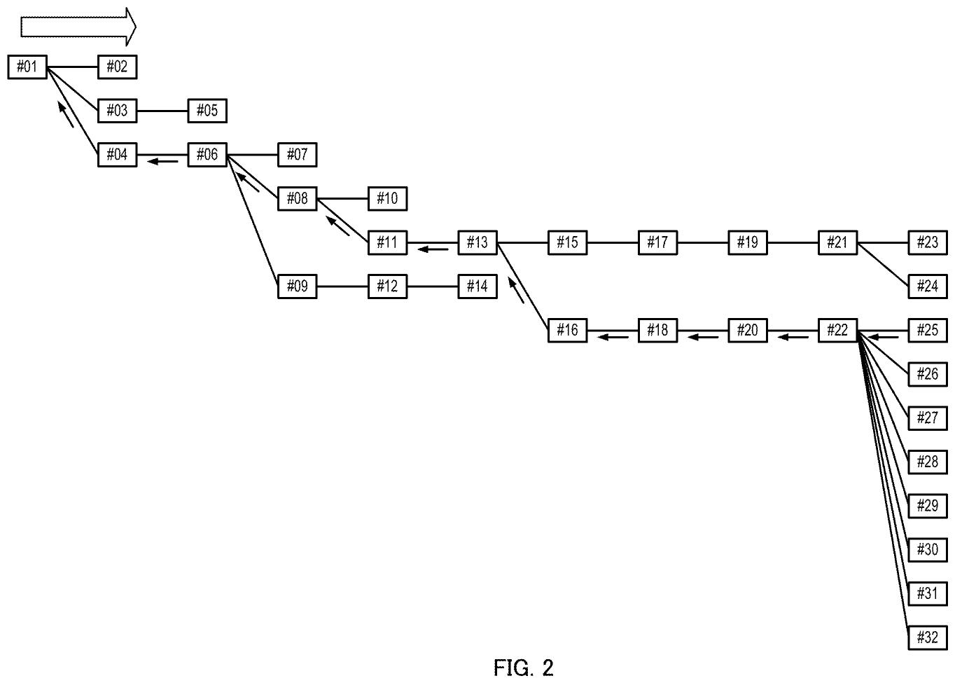

FIG. 2 is a diagram showing example logic communication of a power line communication system shown in FIG. 1. #01 to #32 shown in FIG. 2 correspond to communication apparatuses #01 to #32 shown in FIG. 1. In the following description, a flow of signals from communication apparatus #01 serving as a master to communication apparatuses #02 to #32 serving as terminals may be referred to as “downlink”. A flow of signals from communication apparatuses #02 to #32 serving as terminals to communication apparatus #01 serving as a master may be referred to as “uplink”. A signal may include a packet.

Communication apparatuses #01 to #32 of the power line communication system shown in FIG. 1 have logical connections (topology) shown in FIG. 2, for example. Communication apparatuses #01 to #32 form a tree structure having communication apparatus #01 serving as a master as a route node in logical connections.

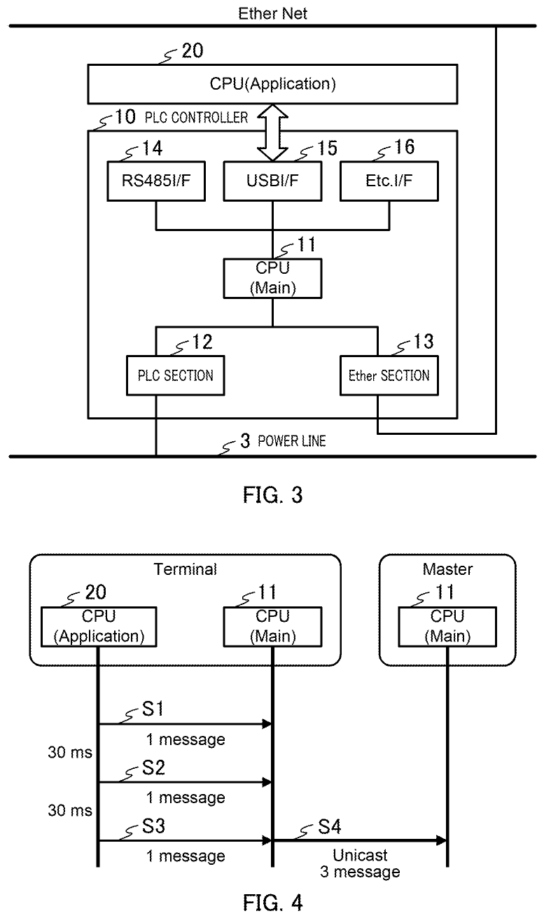

In conventional PLC, for example, communication apparatus #01 serving as a master and communication apparatuses #02 to #32 serving as terminals broadcast signals at the MAC layer level (for example, PLC section 12 in FIG. 3). They also determine signals received at the application level (for example, CPU 20 in FIG. 3) (control of signal destination and source).

For example, it is assumed that communication apparatus #25 serving as a terminal transmits signals to communication apparatus #17 serving as a terminal. In this case, communication apparatus #25 serving as a terminal broadcasts signals at the MAC layer level. Broadcasted signals flow in both the uplink and downlink directions.

Communication apparatuses #01 to #32 determine signals that should be received at the application level. For example, communication apparatus #17 determines a broadcasted signal as a signal that should be received at the application level. The communication apparatuses in the other terminals determine a broadcasted signal as a signal that should not be received at the application level. Accordingly, a signal transmitted from communication apparatus #25 is received at communication apparatus #17.

When different communication apparatuses broadcast signals concurrently, signals flow in both the uplink and downlink directions. For this reason, in some cases at the MAC layer level of communication apparatuses #01 to #32, collision of signals may be more likely to occur, which may cause signal loss and decrease the communication rate.

To solve this problem, in the power line communication system according to the first embodiment, communication apparatuses #02 to #32 serving as terminals transmit signals to communication apparatus #01 serving as a master in a unicast manner. Upon reception of a signal transmitted in a unicast manner, communication apparatus #01 serving as a master broadcasts and transmits the received signal to communication apparatuses #2 to #32.

For example, as in the aforementioned example, communication apparatus #25 serving as a terminal shown in FIG. 2 transmits signals to communication apparatus #17 serving as a terminal. In this case, communication apparatus #25 serving as a terminal transmits signals to communication apparatus #01 serving as a master in a unicast manner. Upon reception of a unicast signal, communication apparatus #01 serving as a master broadcasts and transmits the received signal to communication apparatus #17.

As described above, the power line communication system according to the first embodiment broadcasts signals in the downlink direction but sends unicast signals in the uplink direction. Accordingly, the power line communication system according to the first embodiment reduces collision between signals, and reduces a decrease in communication rate.

As described below, communication apparatuses #01 to #32 aggregate and transmit signals (packets). This reduces the number of signals flowing to power source line 3, collision between signals, and a decrease in communication rate.

It should be noted that the application level corresponds to a layer higher than the MAC layer. For example, the application level may correspond to the application layer.

FIG. 3 is a diagram showing an example block configuration of communication apparatus #01. As shown in FIG. 3, communication apparatus #01 includes PLC controller 10 and a central processing unit (CPU) 20. PLC controller 10 includes CPU 11, PLC section 12, Ether section 13, RS485 I/F (InterFace: I/F) 14, universal serial bus (USB) I/F 15, and Etc. I/F 16. PLC controller 10 may be composed of, for example, one semiconductor chip.

CPU 11 controls the entire PLC controller 10. For example, CPU 11 outputs a signal that PLC section 12 has received from power source line 3 to CPU 20 via any one of RS485 I/F 14, USB I/F 15, and Etc. I/F 16. CPU 11 also outputs, for example, a signal that Ethernet section 13 has received from the Ethernet (Registered Trademark), to CPU 20 via any one of RS485 I/F 14, USB I/F 15, and Etc. I/F 16.

CPU 11 also receives a signal output from CPU 20 via any one of RS485 I/F 14, USB I/F 15, and Etc. I/F 16 and outputs the signal to PLC section 12. CPU 11 also receives a signal output from CPU 20 via any one of RS485 I/F 14, USB I/F 15, and Etc. I/F 16 and outputs the signal to Ethernet section 13.

PLC section 12 is connected to power source line 3. PLC section 12 outputs a signal received from power source line 3 to CPU 11. PLC section 12 also outputs a signal output from CPU 11 to power source line 3. PLC section 12 performs processing in the physical layer and MAC layer in PLC.

Ethernet section 13 is connected to the Ethernet. Ethernet section 13 outputs a signal received from the Ethernet to CPU 11. Ethernet section 13 also outputs a signal output from CPU 11, to the Ethernet.

RS485 I/F 14 is an interface that communicates with CPU 20 according to RS485. USB I/F 15 is an interface that communicates with CPU 20 according to USB. Etc. I/F 16 is an interface that communicates with CPU 20 according to a communication standard other than RS485 I/F 14 and USB I/F 15. It should be noted that CPU 20 may be incorporated in CPU 11. In this case, the I/Fs are unnecessary.

CPU 20 performs processing for communication among communication apparatuses #01 to #32 at the application level. CPU 20 may execute communication processing based on, for example, the Lon Talk protocol.

In FIG. 3, a storage apparatus (for example, read only memory (ROM)) for storing programs executed by CPU 11 is omitted. In FIG. 3, a storage apparatus (for example, random access memory (RAM)) for storing various data needed for processing for programs executed by CPU 11 is omitted. PLC controller 10 may include a storage apparatus for storing programs executed by CPU 11 and a storage apparatus for storing various data needed for processing for programs executed by CPU 11.

In FIG. 3, a storage apparatus (for example, ROM) for storing programs executed by CPU 20 is omitted. In FIG. 3, a storage apparatus (for example, RAM) for storing various data needed for processing for programs executed by CPU 20 is omitted.

Although CPU 11 and PLC section 12 are separate, they may be one piece.

Communication apparatuses #02 to #32 serving as terminals have the same block configuration as communication apparatus #01 serving as a master shown in FIG. 3.

PLC sections 12 of communication apparatuses #02 to #32 serving as terminals have, for example, a storage apparatus inside or outside, and stores the basic service set identifier (BSSID) of communication apparatus #01 serving as a master in the storage apparatus. When the power line communication system shown in FIG. 1 is constructed, PLC section 12 of communication apparatus #01 serving as a master may transmit the BSSID of communication apparatus #01 serving as a master to communication apparatuses #02 to #32 serving as terminals. Accordingly, PLC sections 12 of communication apparatuses #02 to #32 serving as terminals can store the BSSID of communication apparatus #01 serving as a master.

When transmitting signals (packets) to other communication apparatuses #02 to #32 serving as terminals, PLC sections 12 of communication apparatuses #02 to #32 serving as terminals transmit the signals to communication apparatus #01 serving as a master in a unicast manner. For example, PLC sections 12 of communication apparatuses #02 to #32 serving as terminals transmit the signals to communication apparatus #01 serving as a master in a unicast manner using the BSSID of communication apparatus #01 serving as the master stored in the storage apparatus. Upon reception of the signals (the signals including the BSSID of communication apparatus #01) transmitted in a unicast manner, communication apparatus #01 serving as a master transmits the received signals to communication apparatuses #02 to #32 in a broadcast manner.

As described above, PLC sections 12 of communication apparatuses #02 to #32 serving as terminals transmit signals to communication apparatus #01 serving as a master at the MAC layer level in a unicast manner. Hence, communication apparatuses #01 to #32 broadcast signals in the downlink direction but send unicast signals in the uplink direction, thereby reducing collision between signals and a decrease in communication rate.

Packet aggregation in communication apparatuses #02 to #32 serving as terminals will now be described. In the following description, communication apparatus #01 serving as a master may be denoted as a master. Communication apparatuses #02 to #32 serving as terminals may be denoted as terminals. Further, in the following description, the number of terminals is supposed to be 18.

CPU 11 of a terminal aggregates (couples) signals (packets) to be transmitted to the master. PLC section 12 of the terminal transmits the packet coupled by CPU 11 to the master in a unicast manner.

For example, CPU 11 of the terminal couples, every predetermined time (in predetermined cycles), packets to be transmitted to the master. For example, CPU 11 of the terminal couples, every 220 ms, packets to be transmitted to the master.

In the case where a predetermined number of packets to be transmitted to the master occur before the lapse of a predetermined time, CPU 11 of the terminal couples the predetermined number of packets before the lapse of the predetermined time. For example, in the case where three packets to be transmitted to the master occur before the lapse of 220 ms, CPU 11 of the terminal couples the three packets before the lapse of 220 ms. PLC section 12 of the terminal transmits the packet coupled by CPU 11 to the master in a unicast manner before the lapse of 220 ms.

It should be noted that each PLC section 12 may have the aforementioned aggregating function.

The predetermined time, which is not fixed, is shortened when the number of packets to be transmitted to the master per unit time is small, and is extended when it is large, which can minimize a delay in packet transmission when the number of packets per unit time is small.

FIG. 4 is a sequence diagram showing example processing in a terminal for transmitting packets to a master. FIG. 4 is a sequence diagram showing the case where a predetermined number of (for example, three) packets occur before the lapse of a predetermined time (for example, 220 ms).

CPU 20 of a terminal generates packets (one message) to be transmitted to another terminal every 30 ms, and transmits them to CPU 11 of PLC controller 10 (Steps S1 to S3).

When the number of packets transmitted from CPU 20 reaches three (predetermined number) before the lapse of 220 ms (predetermined time), CPU 11 of the terminal couples three packets (into one packet). PLC section 12 of the terminal sets the BSSID of the master as the destination of the packet coupled by CPU 11, and sends the coupled packet to the master in a unicast manner (Step S4).

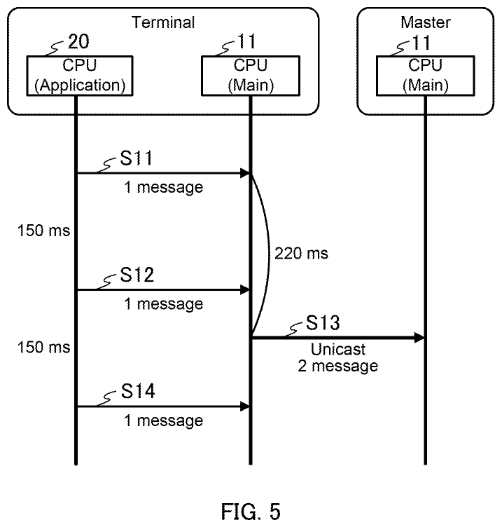

FIG. 5 is a sequence diagram showing example processing in a terminal for transmitting packets to a master. FIG. 5 is a sequence diagram showing the case where a predetermined number of (for example, three) packets do not occur before the lapse of a predetermined time (for example, 220 ms).

CPU 20 of a terminal generates packets (one message) to be transmitted to another terminal every 150 ms, and transmits them to CPU 11 of PLC controller 10 (Steps S11, S12, and S14).

Upon the lapse of 220 ms (predetermined time) before the number of packets transmitted from CPU 20 reaches three (predetermined number), CPU 11 of the terminal couples the packets transmitted from CPU 20 (into one packet). In the example shown in FIG. 5, 220 ms has lapsed before reception of the third packet, and CPU 11 thus couples the two packets that have been received until then. PLC section 12 of the terminal sets the BSSID of the master as the destination of the coupled packet, and sends the coupled packet to the master in a unicast manner (Step S13).

Packet aggregation in a master will now be described.

When transmitting signals (packets) to a terminal, CPU 11 of the master aggregates (couples) the packets. PLC section 12 of the master transmits the coupled packet to the terminal in a broadcast manner.

For example, CPU 11 of the master couples, every predetermined time, (in predetermined cycles) packets to be transmitted to the terminal. For example, CPU 11 of the master couples, every 20 ms, packets to be transmitted to the terminal.

The maximum number of packets to be coupled every predetermined time is predetermined. For example, the maximum number of packets to be coupled every 20 ms is 50 packets. When more than 50 packets occur (packets to be broadcasted to terminals occur) within 20 ms, CPU 11 of the master couples excessive portions of the 50 packets in the next timing (after the lapse of the next 20 ms).

Note that the predetermined time, which is not fixed, is shortened when the number of packets to be transmitted to the terminal per unit time is small, and is extended when it is large, which can minimize a delay in packet transmission when the number of packets per unit time is small.

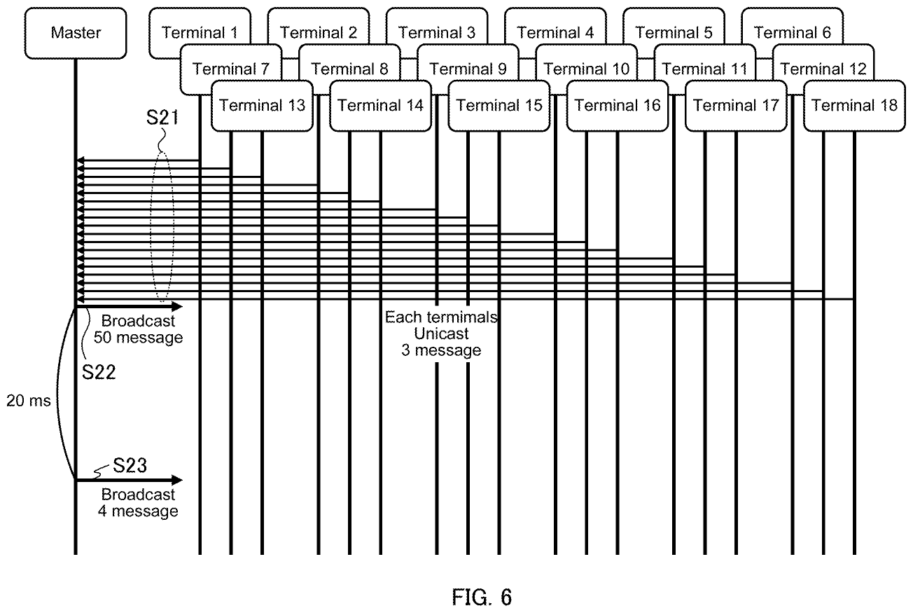

FIG. 6 is a sequence diagram showing example processing in which a master receives and transmits packets from/to terminals. In FIG. 6, each terminal couples three messages (packets) into one packet and transmits it to the master in a unicast manner. Further, in FIG. 6, the master couples, every 20 ms, the packets received from the terminals and broadcasts it to the terminals. The maximum number of packets coupled by the master is 50.

PLC section 12 of the master receives packets transmitted from the terminals in a unicast manner (Step S21).

In FIG. 6, PLC section 12 of the master receives one packet from each of 18 terminals. As described above, this one packet consists of three packets coupled. Accordingly, CPU 11 of the master receives 54 packets from the terminals via PLC section 12.

CPU 11 of the master couples, every 20 ms, at most 50 packets. In Step S21, CPU 11 of the master, which has received 54 packets, couples 50 packets. PLC section 12 of the master transmits the coupled packet (one packet including 50 messages) to the terminals in a broadcast manner (Step S22).

CPU 11 of the master couples the remaining four packets after the next 20 ms. PLC section 12 of the master transmits the coupled packets (one packet including four messages) to the terminals in a broadcast manner (Step S23).

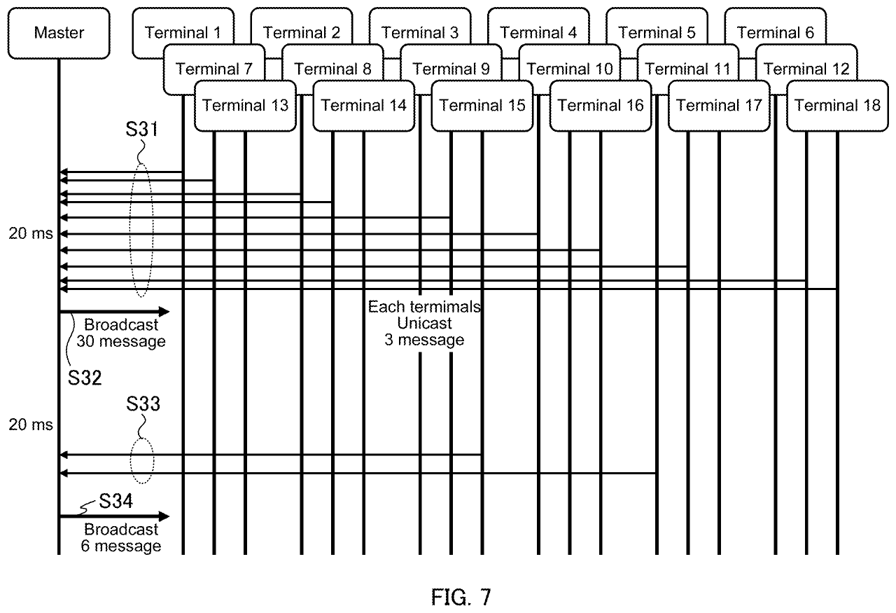

FIG. 7 is a sequence diagram showing example processing in which a master receives and transmits packets from/to terminals. In FIG. 7, each terminal couples three messages (packets) into one packet and transmits it to the master in a unicast manner. Further, in FIG. 7, the master couples, every 20 ms, the packets received from the terminals and broadcasts it to the terminals. The maximum number of packets coupled by the master is 50.

PLC section 12 of the master receives packets transmitted from the terminals in a unicast manner (Step S31).

In FIG. 7, PLC section 12 of the master receives one packet from each of 10 terminals. As described above, this one packet consists of three packets coupled. Accordingly, CPU 11 of the master receives 30 packets from the terminals via PLC section 12.

CPU 11 of the master couples, every 20 ms, at most 50 packets. In Step S31, CPU 11 of the master, which has received 30 packets, couples 30 packets. PLC section 12 of the master transmits the coupled packet (one packet including 30 messages) to the terminals in a broadcast manner (Step S32).

PLC section 12 of the master receives one packet from each of 2 terminals by the next 20 ms (Step S33). As described above, this one packet consists of three packets coupled. Accordingly, CPU 11 of the master receives 6 packets from the terminals via PLC section 12.

CPU 11 of the master couples, every 20 ms, at most 50 packets. In Step S33, CPU 11 of the master, which has received 6 packets, couples 6 packets. PLC section 12 of the master transmits the coupled packet (one packet including 6 messages) to the terminals in a broadcast manner (Step S34).

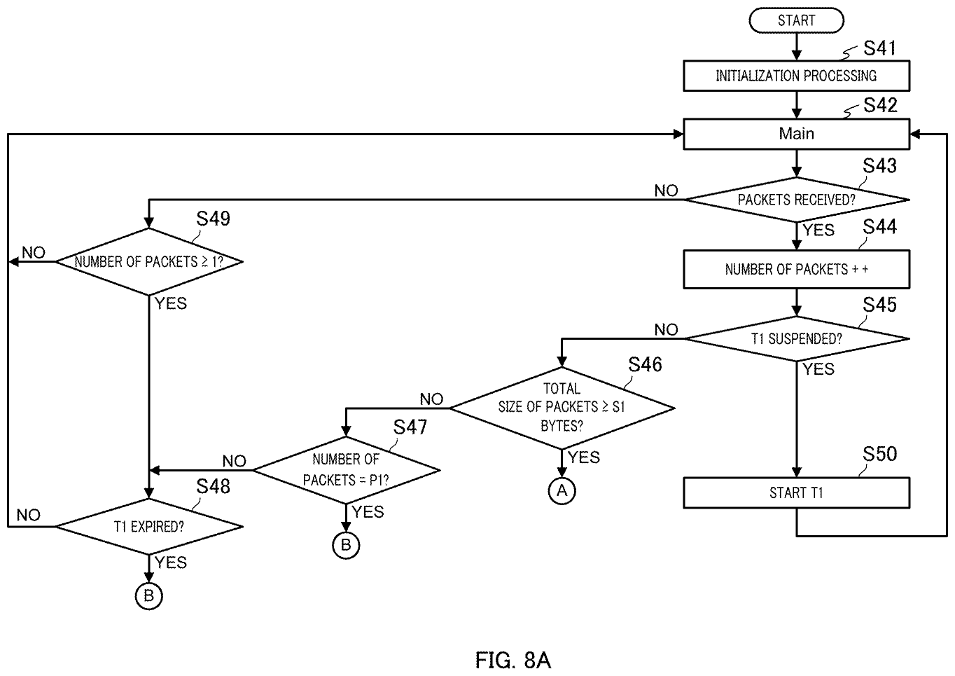

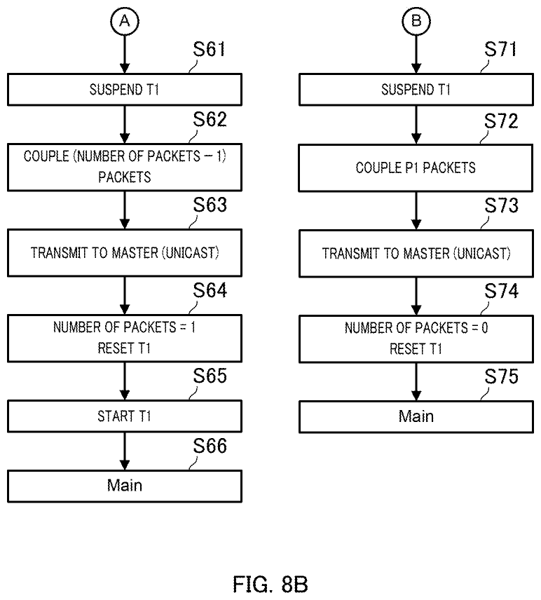

FIGS. 8A and 8B are flow charts showing example processing in a terminal. For example, the terminal, when powered, starts the processing of the flow chart shown in FIGS. 8A and 8B.

First, CPU 11 and PLC section 12 of the terminal perform initialization processing of timers, variables, and the like (Step S41). For example, CPU 11 initializes, for example, the timer count value and variable to 0. Upon completion of the initialization processing of timers, variables, and the like, CPU 11 proceeds to process the main routine (Step S42). CPU 11 processes nothing in the main routine and proceeds to processing in Step S43. Needless to say, CPU 11 may perform some processing in the main routine and proceed to processing in Step S43.

CPU 11 determines whether or not it has received packets from CPU 20 (Step S43).

When it is determined that it has received packets from CPU 20 (“YES” in S43), CPU 11 increments the variable “the number of packets” by one (Step S44).

Once CPU 11 increments the variable “the number of packets” by one, CPU 11 determines whether or not a timer T1 is suspended (Step S45).

When it is determined that the timer T1 is suspended (“YES” in Step S45), CPU 11 starts the operation of the timer T1 (Step S50) and returns to the main routine of Step S42. In contrast, when it is determined that the timer T1 is not suspended (“NO” in Step S45), CPU 11 determines whether or not the total size of the packets to be transmitted to the master is “S1” bytes or more (Step S46).

In Step S46, when it is determined that the total size of the packets to be transmitted to the master is “S1” bytes or more (“YES” in S46), CPU 11 suspends the operation of the timer T1 (Step S61 in FIG. 8B).

Once CPU 11 suspends the operation of the timer T1, CPU 11 couples packets the number of which corresponds to the number resulting from subtracting one from the variable “the number of packets” (Step S62). CPU 11 transmits the coupled packet to the master in a unicast manner via PLC section 12 (Step S63). CPU 11 stores “1” in the variable “the number of packets” and resets the timer T1 (Step S64). CPU 11 starts the operation of the timer T1 (Step S65) and returns to the main routine of Step S42 (Step S66).

In Step S46 of FIG. 8A, when it is determined that the total size of the packets received from CPU 20 is not “S1” bytes or more (“NO” in S46), CPU 11 determines whether or not the number of packets that have been received from CPU 20 is “P1” (Step S47).

When it is determined that the number of packets that have been received from CPU 20 is “P1” (“YES” in S47), CPU 11 suspends the operation of the timer T1 (Step S71 in FIG. 8B).

Once CPU 11 suspends the operation of the timer T1, CPU 11 couples P1 packets (Step S72). CPU 11 transmits the coupled packet to the master in a unicast manner via PLC section 12 (Step S73). CPU 11 stores 0 in the variable “the number of packets” and resets the timer T1 (Step S74), and returns to the main routine of Step S42 (Step S75).

In Step S47 of FIG. 8A, when it is determined that the number of packets that have been received from CPU 20 is not “P1” (“NO” in S47), CPU 11 determines whether or not the timer T1 has expired (Step S48).

When it is determined that the timer T1 has expired (“YES” in S48), CPU 11 performs the processing of Steps S71 to S74 described above (however, in Step S72, the number of packets to be coupled is not necessarily P1). In contrast, when it is determined that the timer T1 has not been expired (“NO” in Step S48), CPU 11 returns to the main routine of Step S42.

In Step S43, when it is determined that no packets have been received from CPU 20 (“NO” in S43), CPU 11 determines whether or not the variable “the number of packets” is one or more (Step S49).

When it is determined that the variable “the number of packets” is one or more (“YES” in S49), CPU 11 proceeds to processing in Step S48. In contrast, when it is determined that the variable “the number of packets” is not one or more (“NO” in Step S49), CPU 11 returns to the main routine of Step S42.

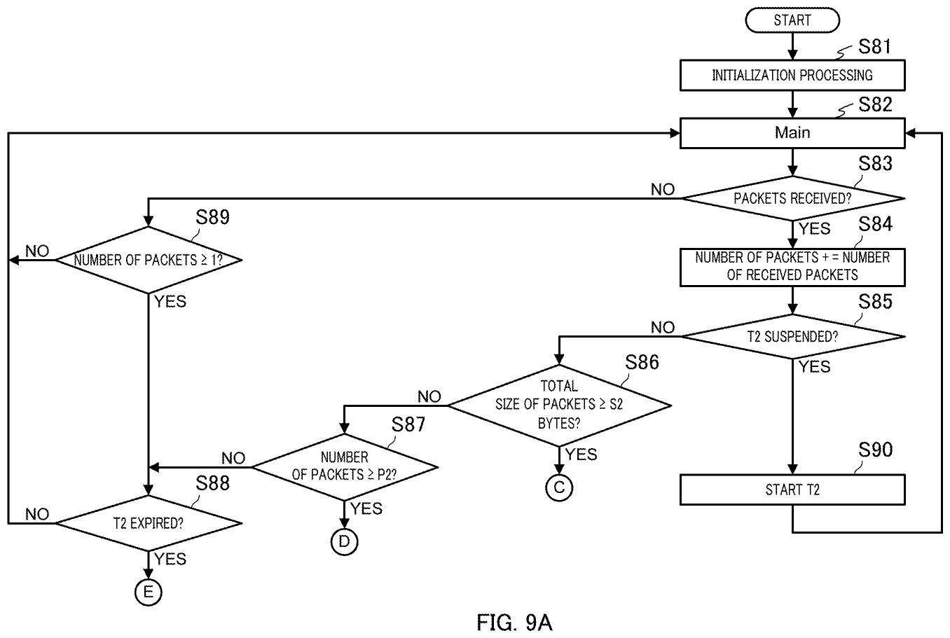

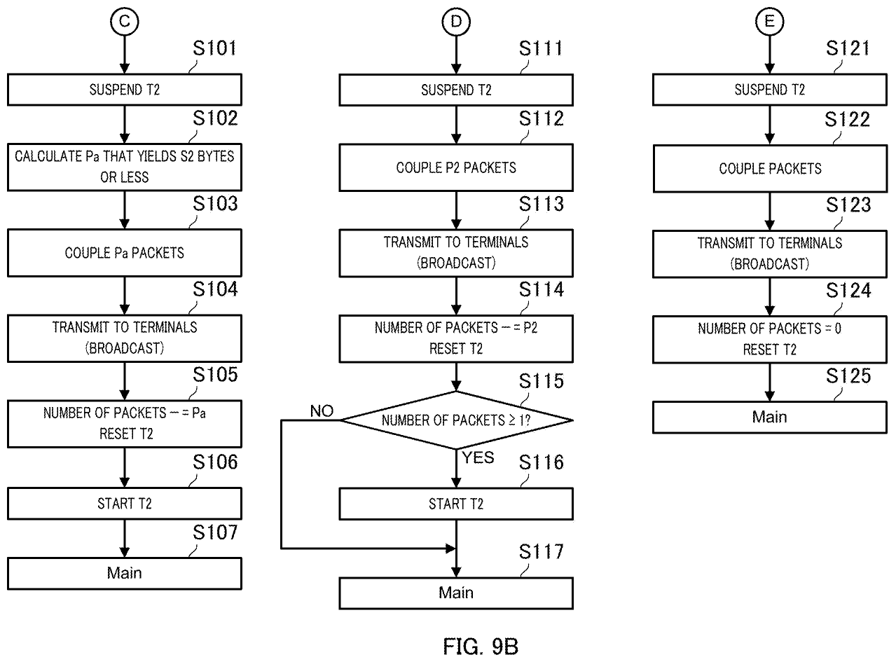

FIGS. 9A and 9B are flow charts showing example processing in a master. For example, when a power is turned on, the master starts the processing of the flow chart shown in FIGS. 9A and 9B.

First, CPU 11 and PLC section 12 of the master perform initialization processing of timers, variables, and the like (Step S81). For example, CPU 11 initializes, for example, the timer count value and variable to 0. Upon completion of the initialization processing of timers, variables, and the like, CPU 11 proceeds to process the main routine (Step S82). CPU 11 processes nothing in the main routine and proceeds to processing in Step S83. Needless to say, CPU 11 may perform some processing in the main routine, and proceed to processing in Step S83.

CPU 11 determines whether or not it has received packets from terminals via PLC section 12 (Step S83).

When it is determined that it has received packets from the terminals (“YES” in S83), CPU 11 adds the number of received packets to the variable “the number of packets” (Step S84).

Once CPU 11 adds the number of packets received from the terminals to the variable “the number of packets”, CPU 11 determines whether or not the operation of a timer T2 is suspended (Step S85).

When it is determined that the operation of the timer T2 is suspended (“YES” in Step S85), CPU 11 starts the operation of the timer T2 (Step S90) and returns to the main routine of Step S82. In contrast, when it is determined that the operation of the timer T2 is not suspended (“NO” in Step S85), CPU 11 determines whether or not the total size of the packets to be transmitted to the terminals is “S2” bytes or more (Step S86). S2 may be equal to S1.

In Step S86, when it is determined that the total size of the packets to be transmitted to the terminals is “S2” bytes or more (“YES” in S86), CPU 11 suspends the operation of the timer T2 (Step S101 in FIG. 9B).

Once CPU 11 suspends the operation of the timer T2, CPU 11 calculates the number of packets “Pa” with which the total size of the packets to be transmitted to the terminals becomes S2 bytes or less (Step S102). CPU 11 couples the calculated “Pa” packets (Step S103). CPU 11 transmits the coupled packet to the terminals in a broadcast manner via PLC section 12 (Step S104). CPU 11 subtracts “Pa” from the variable “the number of packets” and resets the timer T2 (Step S105). CPU 11 starts the operation of the timer T2 (Step S106) and returns to the main routine of Step S82 (Step S107).

In Step S86 of FIG. 9A, when it is determined that the total size of the packets received from the terminals is not “S2” bytes or more (“NO” in S86), CPU 11 determines whether or not the number of packets that have been received from the terminals is “P2” or more (Step S87).

When it is determined that the number of packets that have been received from the terminals is “P2” or more (“YES” in S87), CPU 11 suspends the operation of the timer T2 (Step S111 in FIG. 9B).

Once CPU 11 suspends the operation of the timer T2, CPU 11 couples P2 packets (Step S112). CPU 11 transmits the coupled packet to the terminals in a broadcast manner via PLC section 12 (Step S113). CPU 11 subtracts “Pa” from the variable “the number of packets” and resets the timer T2 (Step S114).

CPU 11 determines whether or not the variable “the number of packets” is one or more (Step S115). If the variable “the number of packets” is one or more (“YES” in S115), CPU 11 starts the operation of the timer T2 (Step S116) and returns to the main routine of Step S82 (Step S117). In contrast, if the variable “the number of packets” is not one or more (“NO” in Step S115), CPU 11 returns to the main routine of Step S82 (Step S117).

In Step S87 of FIG. 9A, when it is determined that the number of packets that have been received from the terminals is not “P2” or more (“NO” in S87), CPU 11 determines whether or not the timer T2 has expired (Step S88).

When it is determined that the timer T2 has expired (“YES” in S88), CPU 11 suspends the operation of the timer T2 (Step S121 in FIG. 9B).

Once CPU 11 suspends the operation of the timer T2, CPU 11 couples packets (Step S122). CPU 11 transmits the coupled packet to the terminals in a broadcast manner via PLC section 12 (Step S123). CPU 11 stores 0 in the variable “the number of packets” and resets the timer T2 (Step S124), and returns to the main routine of Step S82 (Step S125).

In Step S83 in FIG. 9A, when it is determined that no packets have been received from the terminals (“NO” in S83), CPU 11 determines whether or not the variable “the number of packets” is one or more (Step S89).

When it is determined that the variable “the number of packets” is one or more (“YES” in S89), CPU 11 proceeds to processing in Step S88. In contrast, when it is determined that the variable “the number of packets” is not one or more (“NO” in Step S89), CPU 11 returns to the main routine of Step S82.

In this embodiment, a power line communication system includes a master that is located at the route node of a tree structure of logical connection and broadcasts received signals, a sender terminal that is located at a node other than the route node of the tree structure, and a recipient terminal that is located at a node other than the route node of the tree structure. The sender terminal of the power line communication system includes a PLC section 12 that communicates with the master and the recipient terminal through a power line, and PLC section 12 transmits a transmission signal, which is transmitted to the recipient terminal, to the master in a unicast manner. The master broadcasts the transmission signal, which has been transmitted from the sender terminal, to the recipient terminal. Consequently, the terminals and the master can reduce collision between signals and a decrease in communication rate.

Another power line communication system includes a sender terminal that is located at a node other than the route node of a tree structure of logical connection, a recipient terminal that is located at a node other than the route node of the tree structure, and a master that is located at the route node of the tree structure. The master of the power line communication system includes a PLC section 12 that communicates with the sender terminal and the recipient terminal through a power line, and PLC section 12 receives a transmission signal, which is transmitted from the sender terminal, in a unicast manner and transmits the received transmission signal to the recipient terminal in a broadcast manner. Consequently, the terminals and the master can reduce collision between signals and a decrease in communication rate.

Although the terminal sends signals at the MAC layer level in a unicast manner in the above description, it may be unicast at the internet protocol (IP) layer level. In other words, PLC section 12 of a terminal stores the IP address of the master and assigns the IP address of the master to packets to be transmitted, thereby achieving unicast at the IP layer level.

Signal reception at communication apparatus #01 serving as a master may include unicast reception by PLC and signal reception from the application (CPU 20) of communication apparatus #01.

### Second Embodiment

In the first embodiment, for example, as it has been described referring to FIG. 2, signals are sent in a unicast manner in the uplink direction and in a broadcast manner in the downlink manner. In the second embodiment, in the downlink direction, signals are sent in a unicast manner to a communication apparatus that is one level lower. Points different from in the first embodiment will be explained below.

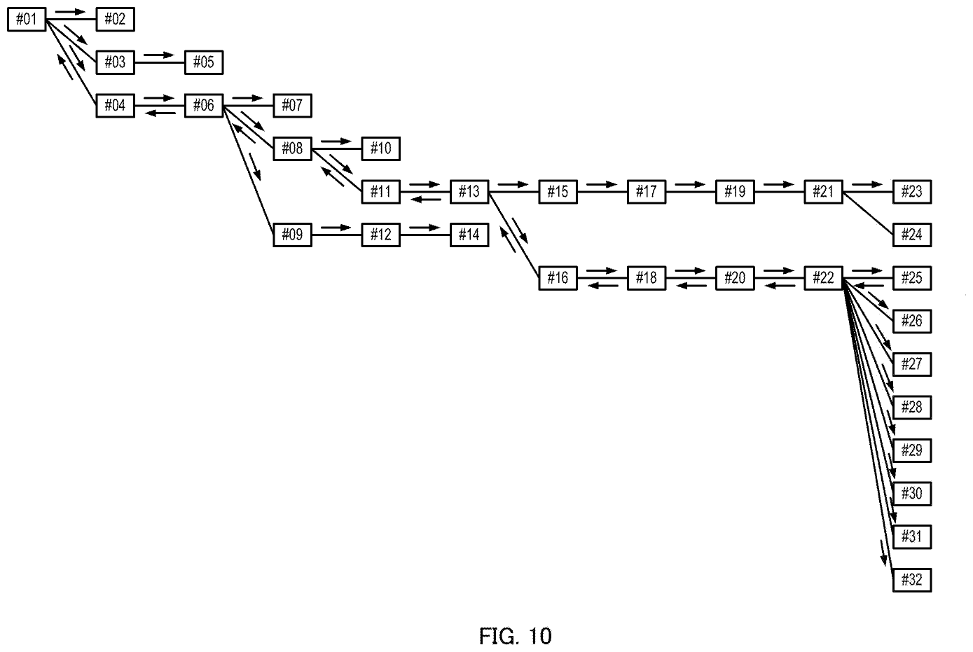

FIG. 10 is a diagram showing example logical connection in a power line communication system according to a second embodiment. #01 to #32 shown in FIG. 10 correspond to communication apparatuses #01 to #32 shown in FIG. 1. Points different from in FIG. 2 will be explained below.

Communication apparatuses #01 to #32 transmit downlink signals in a unicast manner to the respective communication apparatuses #01 to #32 that are one level lower.

For example, upon reception of a signal transmitted in a unicast manner, communication apparatus #01 serving as a master transmits the received signal in a unicast manner to communication apparatuses #02, #03, and #04 that are one level lower terminals.

Communication apparatuses #02, #03, and #04 one level lower than the master each transmit the signal received from communication apparatus #01, to the one level lower terminal in a unicast manner. For example, communication apparatus #03 transmits the signal to communication apparatus #05 that is the one level lower terminal in a unicast manner. Communication apparatus #04 transmits the signal to communication apparatus #06 that is the one level lower terminal in a unicast manner. Since no communication apparatus one level lower than communication apparatus #02 is connected, communication apparatus #02 does not transmit any signal.

Communication apparatus #06 transmits the signal, which has been transmitted from the one level higher communication apparatus #04 in a unicast manner, to the one level lower communication apparatuses #07, #08, and #09 in a unicast manner. Similarly, communication apparatuses #07, #08, and #09 and the communication apparatuses disposed in the levels lower than communication apparatuses #07, #08, and #09 transmit signals to the respective one level lower communication apparatuses in a unicast manner.

PLC sections 12 of communication apparatuses #01 to #32 each have, for example, a storage apparatus inside or outside, and stores the BSSID of the one level lower communication apparatus in the storage apparatus. When the power line communication system shown in FIG. 1 is constructed, PLC sections 12 of communication apparatuses #02 to #32 may transmit the BSSID to the one level higher communication apparatuses. Accordingly, PLC sections 12 of communication apparatuses #01 to #32 can store the BSSID of the one level lower communication apparatus #01. PLC sections 12 of communication apparatuses #01 to #32 can then set the BSSID of the one level lower communication apparatus to the packet destination.

In this embodiment, a power line communication system includes a sender terminal that is located at a node other than the route node of a tree structure of logical connection, a recipient terminal that is located at a node other than the route node of the tree structure, and a master that is located at the route node of the tree structure. The master of the power line communication system includes a PLC section 12 that communicates with the sender terminal and the recipient terminal through a power line, and PLC section 12 receives a transmission signal, which is transmitted from the sender terminal, in a unicast manner and transmits the received transmission signal to the recipient terminal in a unicast manner. Consequently, the terminals and the master can reduce collision between signals and a decrease in communication rate.

Note that the master may have the function of aggregating packets described in the first embodiment.

In the first and second embodiments, communication apparatus #01 serving as a master may grasp the logical connection in the power line communication system (may store information on the logical connection relationship in a storage section). Communication apparatuses #02 to #32 serving as terminals may inquire information on the logical connection from the master, thereby, for example, acquiring information on the communication apparatuses that are one level higher and one level lower in the logical connection.

Each block used for description of the aforementioned embodiment is implemented typically in the form of LSI, which is an integrated circuit. They may be separate chips or part or all of them may be made into one chip. Although LSI is taken here, it may be referred to as IC, system LSI, super LSI, or ultra LSI depending on the integration degree.

Further, the method of circuit integration is not limited to LSI, and may be implemented using dedicated circuitry or general-purpose processors. A field programmable gate array (FPGA), which is programmable after LSI production, or a reconfigurable processor in which connection and settings of circuit cells in the LSI can be reconfigured may be used.

Furthermore, needless to say, if integrated circuit technology comes out to replace LSI as a result of the progress of semiconductor technology or other derivative technology, function block integration may be performed using that technology. Applications of biotechnology or the like may be possible.

### INDUSTRIAL APPLICABILITY

The present disclosure is advantageous in a communication apparatus for power line communication.

### REFERENCE SIGNS LIST

1 Communication apparatus
2 PLC isolator
3 Power source line
4 Attenuator
10 PLC controller
11,20 CPU
12 PLC section
13 Ethernet section
14 RS485 I/F
15 USB I/F
16 Etc. I/F

1. A sender communication apparatus of a power line communication system that includes:
a communication apparatus that is located at a route node of a tree structure of logical connection and broadcasts a received signal;
the sender communication apparatus that is located at a node other than the route node of the tree structure; and
a recipient communication apparatus that is located at a node other than the route node of the tree structure, wherein
the sender communication apparatus comprises a communicator that communicates with the communication apparatus and the recipient communication apparatus via a power line, and
the communicator transmits transmission signals to be transmitted to the recipient communication apparatus, to the communication apparatus in a unicast manner.

2. The sender communication apparatus according to claim 1, further comprising a controller that couples the transmission signals to be transmitted to the recipient communication apparatus, wherein
the communicator transmits the coupled transmission signals to the communication apparatus in a unicast manner every predetermined time.

3. The sender communication apparatus according to claim 2, wherein when the number of the coupled transmission signals reaches a predetermined number before a lapse of the predetermined time, the communicator transmits the predetermined number of coupled transmission signals before the lapse of the predetermined time.

4. The sender communication apparatus according to claim 2, wherein when a total size of the coupled transmission signals reaches or exceeds a predetermined size before a lapse of the predetermined time, the communicator transmits a certain number of the transmission signals before the lapse of the predetermined time, the certain number resulting from subtracting one from the number of the coupled transmission signals.

5. The sender communication apparatus according to claim 2, wherein the communicator shortens the predetermined time when the number of the transmission signals per unit time is small, and extends the predetermined time when the number of the transmission signals per unit time is large.

6. A communication apparatus of a power line communication system that includes:
a sender communication apparatus that is located at a node other than a route node of a tree structure of logical connection;
a recipient communication apparatus that is located at a node other than the route node of the tree structure; and
the communication apparatus that is located at the route node of the tree structure, wherein
the communication apparatus comprises a communicator that communicates with the sender communication apparatus and the recipient communication apparatus via a power line, and
the communicator receives, in a unicast manner, transmission signals transmitted from the sender communication apparatus, and transmits the received transmission signals to the recipient communication apparatus in a broadcast manner.

7. The communication apparatus according to claim 6, further comprising a controller that couples the transmission signals received from the sender communication apparatus in a unicast manner, wherein
the communicator transmits the coupled transmission signals to the recipient communication apparatus in a broadcast manner every predetermined time.

8. The communication apparatus according to claim 7, wherein when the number of the coupled transmission signals reaches a predetermined number before a lapse of the predetermined time, the communicator transmits the predetermined number of coupled transmission signals before the lapse of the predetermined time.

9. The communication apparatus according to claim 7, wherein when a total size of the coupled transmission signals reaches or exceeds a predetermined size before a lapse of the predetermined time, the communicator transmits the transmission signals having the total size made less than or equal to a predetermined size before the lapse of the predetermined time.

10. The communication apparatus according to claim 7, wherein the communicator shortens the predetermined time when the number of the transmission signals per unit time is small, and extends the predetermined time when the number of the transmission signals per unit time is large.

11. A communication apparatus of a power line communication system that includes:
a sender communication apparatus that is located at a node other than a route node of a tree structure of logical connection;
a recipient communication apparatus that is located at a node other than the route node of the tree structure; and
the communication apparatus that is located at the route node of the tree structure, wherein
the communication apparatus comprises a communicator that communicates with the sender communication apparatus and the recipient communication apparatus via a power line, and
the communicator receives, in a unicast manner, transmission signals transmitted from the sender communication apparatus, and transmits the received transmission signals to the recipient communication apparatus in a unicast manner.

12. The communication apparatus according to claim 11, further comprising a controller that couples the transmission signals received from the sender communication apparatus in a unicast manner, wherein
the communicator transmits the coupled transmission signals to the recipient communication apparatus in a unicast manner every predetermined time.

13. The communication apparatus according to claim 12, wherein when the number of the coupled transmission signals reaches a predetermined number before a lapse of the predetermined time, the communicator transmits the predetermined number of coupled transmission signals before the lapse of the predetermined time.

14. The communication apparatus according to claim 12, wherein when a total size of the coupled transmission signals reaches or exceeds a predetermined size before a lapse of the predetermined time, the communicator transmits the transmission signals having the total size made less than or equal to a predetermined size before the lapse of the predetermined time.

15. The communication apparatus according to claim 12, wherein the communicator shortens the predetermined time when the number of the transmission signals per unit time is small, and extends the predetermined time when the number of the transmission signals per unit time is large.
